(19) United States
(12) Patent Application Publication
(10) Pub. No.: US 2009/0233570 A1
(43) Pub. Date: Sep. 17, 2009

(54) RECEIVER FRONT-END WITH LOW POWER CONSUMPTION

(75) Inventor: Zhenhua Wang, Zurich (CH)

Correspondence Address: SEED INTELLECTUAL PROPERTY LAW GROUP PLLC, 701 FIFTH AVENUE, SUITE 5400, SEATTLE, WA, 98104-7092, US

(73) Assignee: ST-ERICSSON SA, Geneva (CH)

(21) Appl. No.: 12/467,937

(22) Filed: May 18, 2009

Related U.S. Application Data
(62) Division of application No. 10/555,397, filed on Nov. 2, 2005.

(30) Foreign Application Priority Data
May 7, 2003 (EP) 03101262.8

(51) Int. Cl. H04B 1/16

(52) U.S. Cl. 455/323

(57) ABSTRACT

A receiver includes a mixer with a first input, a second input and one output. An input signal (S_{RF}(t)), which has a high frequency component f_{RF}, is applied to the first input, and a local oscillator signal (S_{LOnew}(t)) is applied to the second input of the mixer. The local oscillator signal (S_{LOnew}(t)) is generated by a source and the local oscillator signal (SLOnew(t)) has a frequency component with a frequency f_{LO}. The frequency f_{LOnew} is at least three times lower than the frequency f_{RF} of the input signal (S_{RF}(t)). The mixer down-converts the input signal (S_{R}F(t)) to a lower frequency band.

### BACKGROUND

1. Technical Field

This invention relates to receivers, transceiver, and integrated circuits for information transmission. More particularly, this invention relates to a radio frequency (RF) receiver front-end for data communication and devices based thereon.

2. Description of the Related Art

The competition in the communication market is extremely fierce and business success relies increasingly upon the constant product innovation. For a semiconductor provider specialized in communications ICs and system solutions, this means innovations in both system architecture and circuit techniques in order to be able to realize low-cost, low-power, and small form-factor terminals.

Low power is a research topic both at universities and in the industries. For many applications, such as portable applications for example, the need for low power consumption is most important. The most power in a receiver is dissipated in the front-end, so logically it is the primary focus of low-power research activities.

In an RF communication system, an RF receiver is employed that extracts a baseband signal from an RF carrier. This process involves a frequency translation from the RF carrier to the baseband frequency. There are two types of receivers depending on the manner this frequency translation takes place: heterodyne receivers and homodyne receivers. The same is the case for optical communication systems, where heterodyne receivers and homodyne receivers are employed as well.

Conventional homodyne and heterodyne receivers comprise a voltage controlled oscillator (VCO) issuing a signal having a frequency f_{LO}. To be more specific, the frequency f_{LO} in a receiver is normally generated by the VCO placed in a phase-locked-loop (PLL). The frequency f_{LO} is chosen either to be equal to the frequency of a radio frequency (RF) signal received at the transceiver's antenna (referred to as homodyne receiver), thus converting the RF signal directly down to the base band. Such homodyne receivers are by some manufacturers referred to as zero intermediate frequency receivers. Or, a frequency f_{LO} very close to the radio frequency f_{RF} is chosen in a so-called super heterodyne receiver, translating the RF signal in a first step to the intermediate frequency (IF), then to base band in a second or even third step.

A conventional homodyne RF receiver 10 with a VCO 15 placed in a phase-locked-loop (PLL) is illustrated in FIG. 1. The receiver 10 comprises an antenna 11, a low-noise amplifier (LNA) 12, and mixer 13. A local oscillator signal f_{LO} is generated by a part of the receiver that comprises a reference oscillator 18, a phase detector 17, a divider 16, a VCO 15, a low-pass filter 19, and a buffer/amplifier 14. An input signal s(t) comprising a high frequency component (f_{RF}) and a local oscillator signal (f_{LO}) are applied to the inputs of the mixer 13 and the mixer provides for a down-conversion of the input signal s(t) to a signal r(t) at a lower frequency band.

In such a homodyne RF receiver but also in heterodyne RF receivers, the LO frequency (f_{LO}) is very high. In GSM, for example, f_{RF} lies in 900 MHz, in DCS in 1800 MHz, and in Bluetooth, it is even higher in the ISM band of 2450 MHz. In a receiver, the VCO 15, the following buffer 14, and the divider 16, etc. operate roughly at such a high frequency, and hence consume quite a lot of power. Particularly the VCO 15, which, quite often, is designed to operate at even doubled frequency in order to generate in-phase and quadrature signals of the desired LO frequency f_{LO}. The current drawn by a LC VCO, for example, is proportional to squared oscillation frequency, i.e.,

Idd_{VCO}≈f_{LO}² (1)

So that switching from 900 MHz to 1800 MHz the power consumption of a VCO will be quadrupled.

In order to provide sufficient isolation and to provide an adequate amplitude at the mixer input, a buffer/amplifier 14 is almost always required between the VCO 15 and the mixer 13. The buffer/amplifier circuit 14 has to be wideband in order to allow the mixer 13 for current commutating with fast switching. For this reason, practical VCO buffers/amplifiers 14 are designed to be wideband and, therefore, consume quite a lot of power. For MOSFET implemented buffers/amplifiers 14, the relationship between its drain current Ids and the resultant unity-current gain frequency f_{T} is given by

Ids≈f_{T}² (2)

The unity-current gain frequency f_{T} of the MOS transistor has to match the LO frequency f_{LO}, so every doubling of the LO frequency f_{LO} requires the quadrupled power consumption of the buffer/amplifier 14 (equal to Idd_{BF}*Vdd in FIG. 1)

Frequency dividers (also referred to as prescalers) are essentially digital circuits using logic gates such as dFFs. The dynamic power consumption of a logic circuit is proportional to the clock frequency. So that every doubling of the clock frequency requires a doubling of the divider's dynamic power consumption.

The homodyne and heterodyne receiver front-end used in optical communication systems also consumes a substantial amount of power, since part of the signal processing is done electrically. An example of a homodyne receiver is described in the European patent application as published on 9 May 2001 under the publication number EP 1098459-A2.

One of the most straightforward techniques for reducing power consumed by RF receivers is to lower the voltage. This represents a reduction in power consumption. However, in order for a receiver to maintain a certain dynamic range and thus the ability to operate in poor RF conditions requires a certain voltage level at least for the analog receiver front-end.

There are several other obvious techniques for reducing power consumption. At the system level, one should make partitioning choices so that as much circuitry as possible can be turned off when it is not needed. In addition, functions should be allocated where they can be executed with the minimum power. A certain reduction of the power consumption can further be achieved if one reduces the clock rate of the digital part of a receiver, for instance.

In addition, great efforts have been made and almost everything has been tried to minimize the power of a receiver front-end in particular, since the receiver front-end is known to consume a substantial amount of power. These efforts include increasing the inductance of the LC VCO, decreasing the power supply voltage, as indicated above, and using half-swing logic, just to mention some examples.

These conventional approaches to a reduction of the power consumption are not going far enough. The reductions achievable are not sufficient.

### BRIEF SUMMARY

It is thus an objective of the present invention to provide a scheme for reducing the power consumption of a receiver without impacting the receiver's performance.

In one embodiment, a receiver for receiving an RF signal comprising a high frequency component f_{RF} includes a local oscillator, at least one mixer and at least one filter. The local oscillator provides at least one square wave local oscillator signal. The at least one square local oscillator signal has a fundamental frequency component with a frequency of f_{LOnew}, where f_{LOnew} is at least one-third (⅓) of the high frequency f_{RF}, and the at least one square local oscillator signal has at least one odd harmonic frequency component that is an odd multiple of the fundamental frequency component of f_{LOnew}.

The at least one mixer down-converts the RF signal to a desired output frequency. The at least one mixer has a first input to which the RF signal is applied, a second input to which the at least one square wave local oscillator signal is applied, and an output from which a composite output signal is provided. The composite output signal includes a desired output signal produced by multiplying the fundamental frequency component of the at least one square local oscillator signal with the RF signal, and an undesired output signal produced by multiplying the at least one odd harmonic frequency component of the at least one square local oscillator signal with the RF signal. The desired output signal has an amplitude and a frequency, and the undesired output signal has an amplitude greater than the amplitude of the desired output signal and has a frequency greater than the frequency of the desired output signal.

The at least one filter filters the composite output signal of the at least one mixer to select the desired output signal and reject the undesired output signal.

In one embodiment, a receiver for receiving an RF signal comprising a high frequency component f_{RF} includes an RF amplifier and upper and lower parallel signal processing branches which receive an amplified RF signal output from the RF amplifier.

The upper branch includes a first mixer having an output connected to a first filter, and the first filter has an output connected to a first limiter.

The lower branch includes a second mixer having an output connected to a second filter, and the second filter has an output connected to a second limiter;

The receiver also includes a local oscillator that provides a respective local oscillator signal to each of the upper and lower parallel signal processing branches.

The first mixer performs a multiplication with a first local oscillator signal S′_{LOnew}(t) from the local oscillator (LO) that is phase shifted by 90° and has a frequency f′_{LOnew}.

The second mixer performs a multiplication with a second local oscillator signal S_{LOnew}(t) from the local oscillator (LO) that is not phase shifted and has a frequency f_{LOnew};

The receiver also includes a detector that receives a respective output from both the first limiter and the second limiter and that extracts information from the received outputs.

The frequency of the first signal f′_{LOnew} and second f_{LOnew} output by the local oscillator LO conforms with the following:

A f_{LOnew}=A f′_{LOnew}≦f_{RF}, with A≧5.

It is an advantage of the present invention that it yields unprecedented power reduction in virtually all types of receiver front-ends and devices employing such receiver front-ends.

Immediate benefits of this invention are drastically reduced power consumption and thus improved competitiveness. The proposed receivers, transceivers and integrated circuits based thereon are simple and cheap. The receivers, transceivers and integrated circuits according to the present invention are reliable and can be expected to show a performance that is at least as good as the performance of conventional devices.

Other advantages of the present invention are addressed in connection with the detailed embodiments.

For a more complete description of the present invention and for further objects and advantages thereof, reference is made to the following description, taken in conjunction with the accompanying drawings, in which:

### BRIEF DESCRIPTION OF THE SEVERAL VIEWS OF THE DRAWINGS

FIG. 1 shows a schematic block diagram of a conventional receiver structure;

FIG. 2 shows three diagrams illustrating the conventional mixing process in the frequency domain;

FIG. 3 shows a schematic block diagram of a first receiver in accordance with the present invention;

FIG. 4 shows three diagrams illustrating the inventive mixing process in the frequency domain;

FIG. 5 shows a schematic block diagram of a transceiver in accordance with the present invention;

FIG. 6 shows a schematic block diagram of an optical receiver in accordance with the present invention.

### DETAILED DESCRIPTION

So far it has never been considered to reduce the power consumption by changing the LO frequency f_{LO} of a receiver. Until now this parameter remained untouched although great potential exists, as suggested by the above equations given in the introductory portion of this specification.

One tends to presume that the LO frequency f_{LO} is either specified, or immediately fixed once f_{IF} is chosen, or determined beforehand and, therefore, cannot be changed. Contrary to this public belief, the present invention demonstrates that huge power reductions by a factor of at least 10 can be achieved by lowering the LO frequency f_{LO}, while maintaining the specified f_{IF} and other advantages of the receiver.

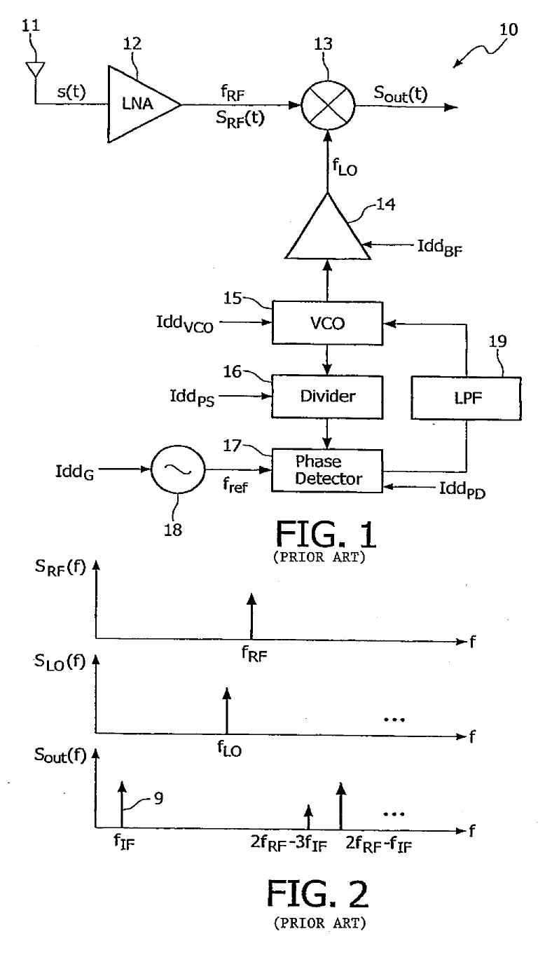

Before demonstrating the feasibility of lowering f_{LO}, the conventional receiver architecture 10 of FIG. 1 is addressed in more detail. FIG. 1 shows a typical receiver architecture 10 with various filters omitted. The very weak RF signal s(t) picked up by the antenna 11 is first amplified by the LNA 12 and then converted from the RF regime down to the IF regime. This down-conversion is done by the mixer 13.

A mixer is a very critical building block and the overall performance of a receiver heavily depend on it. In principle, mixers can be viewed as multipliers. A mixer requires two inputs. In a receiver, the RF signal s(t) is applied to a first mixer input and the LO signal is applied to a second mixer input. The LO signal is generated by a VCO 15 in a frequency synthesizer.

Assuming the input signal coming from the LNA 12 is S_{RF}(t)=sin ω_{RF}(t), and the LO signal provided by the VCO 15 is a square wave of frequency ω_{LO}, described as

$${S}_{LO} ( t ) = \frac{4}{π} [ sin {ω}_{LO} t + \frac{1}{3} sin {ω}_{LO} t + \frac{1}{5} sin 5 {ω}_{LO} t + … ] \qquad ( 3 )$$

Viewing the mixer 13 as a multiplier yields the following result:

$${S}_{out} ( t ) = {S}_{RF} ( t ) \cdot {S}_{LO} ( t ) = \frac{2}{π} [ \begin{matrix}cos {ω}_{IF} t + \frac{1}{3} cos ( 2 {ω}_{RF} - 3 {ω}_{IF} ) t + \\ cos ( 2 {ω}_{RF} - {ω}_{IF} ) t + …\end{matrix} ] \qquad ( 5 )$$

where low-side injection is assumed, i.e., ω_{IF}=ω_{RF}−ω_{LO}. The first term in the bracket of equation (5) is the down converted IF signal, and the rest of the term is unwanted products to be removed by a bandpass (or lowpass) filter, yielding:

$${S}_{outfiltered} ( t ) = \frac{2}{π} [ cos {ω}_{IF} t ] \qquad ( 6 )$$

The mixing process in the frequency domain is illustrated in FIG. 2. The input signal S_{RF}(f) comprising a high frequency component f_{RF} is depicted in the uppermost diagram. The LO signal S_{LO}(f) with frequency f_{LO} is shown in diagram in the middle. The output signal Sₒᵤₜ(f) after mixing is illustrated in the diagram at the bottom. The desired peak 9 is the down converted IF signal with frequency f_{IF}. The other peaks in the diagram at the bottom represent the unwanted terms.

The present invention is based on the recognition that the most efficient way to minimize the power consumption of a receiver VCO is to lower its frequency. In principle, the LO frequency f_{LO} can be lowered by any odd integer. As an example, the attainable power saving is considered by just lowering LO frequency f_{LO} by a factor A=3, resulting in a new LO frequency herein referred to as ω_{LOnew}.

Like the previous LO signal S_{LO}(t), the new LO signal S_{LOnew}(t) with frequency f_{LOnew} is assumed to be a square wave with 50% duty cycle. Similarly, its Fourier series can be written as shown in equation (7):

$${S}_{LOnew} ( t ) = \frac{4}{π} [ \begin{matrix}sin {ω}_{LOnew} t + \\ \frac{1}{3} sin 3 {ω}_{LO new} t + \\ \frac{1}{5} sin 5 {ω}_{LOnew} t + …\end{matrix} ] \qquad ( 7 )$$

Applying the new LO signal S_{LOnew}(t) to the same mixer 13, and for the same RF input signal ω_{RF}(t), again, one obtains the output of the mixer 13 by multiplying both signals:

$${S}_{out} ( t ) = \frac{2}{π} [ \begin{matrix}\frac{1}{3} {cos}_{IF} t + \frac{1}{5} cos ( 2 {ω}_{RF} - 5 {ω}_{IF} ) \frac{t}{3} + \\ cos ( 2 {ω}_{RF} - {ω}_{IF} ) \frac{t}{3} + …\end{matrix} ] \qquad ( 8 )$$

In order to come to the above result, the relationship shown in equation (6) and ω_{IF}=ω_{RF}−ω_{LO} have been used. It can be shown that now one obtains after filtering:

$${S}_{outfiltered} ( t ) = \frac{2}{3 π} [ cos {ω}_{IF} t ] \qquad ( 9 )$$

Comparing this new result in equation (9) with the previous one of equation (5), it is interesting to note that

Both results contain the same desired IF term, at the same IF frequency, meaning that the signals at the output in both cases are exactly the same except a difference in signal level, that is amplitude.

The desired IF term in equations (8) and (9) is smaller, indicating a lower conversion gain. In a Gilbert mixer for example, two circuit portions contribute directly to the conversion gain: One is a transconductance stage which converts the input RF voltage S_{RF}(t) to a current, and the other are the loads, which convert the commutated currents back to a voltage signal Sₒᵤₜ(f). Note that the transconductance stage and its contribution to the conversion gain have not been altered after ω_{LO} is replaced by ω_{LOnew}. As far as the desired IF term is concerned, nothing has been changed with ω_{LOnew} except that now it is the 3rd harmonic of the LO signal that mixes with the input signal S_{RF}(t) and results in the desired IF. Therefore, the gain reduction is purely due to the smaller amplitude of the 3rd harmonic instead of the fundamental. This lower gain is not deemed to be a problem because immediately after down-conversion, it can be easily compensated.

The ratio Θ of the frequency of the next closest unwanted term to the frequency f_{IF} of the desired IF term is an indication of the requirement on the bandpass or lowpass filter that follows the mixer. In a homodyne receiver, this filter selects the desired channel by allowing the IF term to pass without any attenuation while sufficiently rejecting all unwanted terms. Larger ratio Θ means more relaxed requirement. With the f_{LOnew}, frequency, the ratio Θ is slightly reduced but still large enough for any filters.

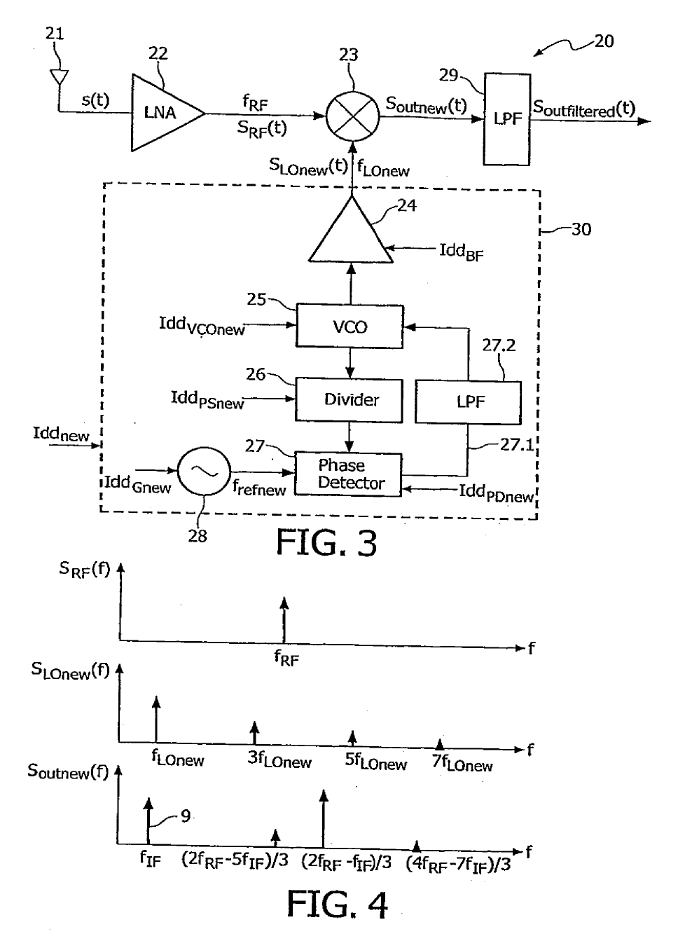

A first inventive embodiment of a receiver 20, in accordance with the above theory, is illustrated in FIG. 3. The receiver 20 comprises an antenna 21 for receiving an RF signal s(t). This signal is amplified by a low noise amplifier 22 and fed to the first input of a mixer 23. The amplified signal is referred to as S_{RF}(t). The receiver 20 further comprises a local oscillator unit 30. This local oscillator unit 30 comprises a reference oscillator 28, e.g. a quartz oscillator, a phase detector 27, a divider 26, a VCO 25, and a buffer 24. According to the present invention, the local oscillator unit 30 provides a LO signal S_{LOnew}(t) with a frequency f_{LOnew}. This LO signal S_{LOnew}(t) is applied to a second input of the mixer 23 and the mixer 23 provides for a down-conversion of the signal S_{RF}(t) to a lower frequency band defined by the frequency f_{IF}. The receiver 20 comprises a low-pass filter (LPF) for filtering the mixer's output signal S_{outnew}(t).

The local oscillator unit 30 provides a reference signal S_{LOnew}(t) required for mixer injection to facilitate frequency translation in the receiver 20. The LO signal S_{LOnew}(t) is a large signal that drives the mixer diodes or transistors into a nonlinear region, thereby allowing the mixer 23 to generate a signal S_{outnew}(t) with fundamental frequencies along with harmonics and mixing terms at the output.

The VCO 25 is locked in phase to a high-stability reference oscillator 28 (for example a crystal oscillator). The phase detector 27 compares the phase of a divided VCO frequency output to that of the precise reference oscillator 28 and creates a correction voltage at the output 27.1 for the VCO 25 based on phase differences between the reference and the VCO. The correction voltage is fed via a LPF 27.2 to the VCO 25.

The local oscillator unit 30 is designed to provide a LO signal S_{LOnew}(t) with a frequency f_{LOnew}≦A f_{RF}, with A≧3. That is, the frequency f_{LOnew} of the LO signal S_{LOnew}(t) is at least 3 times lower than the frequency f_{RF} of the input signal s(t). Due to the fact that a low-frequency LO signal S_{LOnew}(t) is employed instead of a LO signal S_{LO}(t) equal or very close to the frequency f_{RF}, the local oscillator unit 30 consumes less power than a conventional local oscillator unit.

The mixer design uses nonlinear devices, such as diodes or transistors. Using diodes, the mixer is passive and has a conversion loss. Using active devices, such as transistors, a conversion gain is possible. A variety of circuit topologies exist for mixers. A single-ended mixer is usually based on a single Schottky diode or transistor. A balanced mixer typically incorporates two or more Schottky diodes or a Schottky quad (four diodes in a ring configuration). A balanced mixer offers advantages in third-order intermodulation distortion performance compared to a single-ended mixer because of the balanced configuration. Any of these kinds of mixers are suited for being employed in receivers according to the present invention.

The currents flowing into the various building blocks of the local oscillator unit 30 are shown in FIG. 3. If one assumes that all building blocks of the local oscillator unit 30 operate at a reduced frequency, the overall current consumption of the local oscillator unit 30 is

Idd_{new}=Idd_{Gnew}+Idd_{PDnew}+IDD_{PSnew}+Idd_{VCOnew}+IDD_{BF} (10)

To achieve this kind of reduction in current consumption, a reference oscillator 28 may be employed issuing a signal with a lower frequency f_{refnew}. It is also possible to keep the reference oscillator 28 at the usual frequency f_{ref}, but to employ a divider 26 that reduces the frequency in accordance with the present invention.

The mixing process, according to the invention, is illustrated in FIG. 4. The input signal S_{RF}(f) comprising a high frequency component f_{RF} is depicted in the uppermost diagram. The new LO signal S_{LOnew}(f) with a low frequency f_{LOnew} is shown in the diagram in the middle. The output signal S_{outnew}(f) after mixing is illustrated in the diagram at the bottom. The desired peak 9 (cf. FIG. 4) is the down converted IF signal with frequency f_{IF}. The other peaks in the diagram at the bottom represent the unwanted terms.

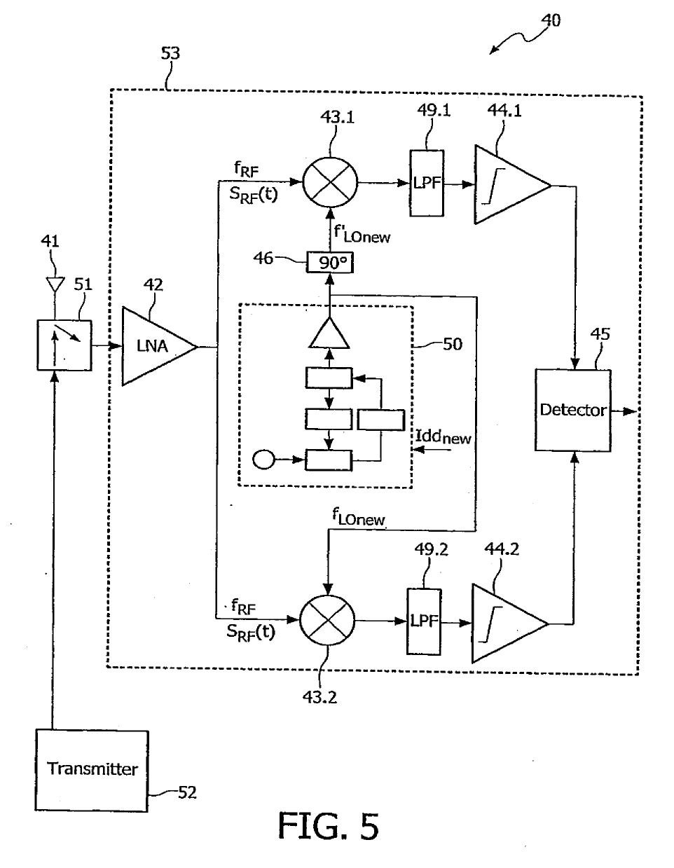

Another embodiment is depicted in FIG. 5. In this Figure, the schematic block diagram of a transceiver 40 is shown. The transceiver comprises a transmitter 51 and a receiver 53. The transmitter 51 and the receiver 53 both use the same antenna 41. There is a unit 51 that discriminates incoming and outgoing signals. The receiver 53 is a zero-IF (homodyne) receiver providing for a narrow baseband filtering with integrated low-pass (LP) filters 49.1, 49.2. At the input side of the receiver 53 there is an RF amplifier 42. There are two parallel signal processing branches. The upper branch comprises a mixer 43.1, the filter 49.1, and a limiter 44.1. The mixer 43.1 of the upper branch performs a multiplication with a LO signal S′_{LOnew}(t) having a frequency f′_{LOnew}. This LO signal S′_{LOnew}(t) is phase shifted by 90°. The phase shifting is carried out by a phase shifter 46. The lower branch comprises a mixer 43.2, the filter 49.2, and a limiter 44.2. The mixer 43.2 of the lower branch performs a multiplication with a LO signal S_{LOnew}(t) having a frequency f_{LOnew}. This LO signal S_{LOnew}(t) is not phase shifted. A detector 45 is provided at the receiver's output side. The detector 45 extracts information from the signal received.

According to the embodiment depicted in FIG. 5, both branches receive a LO signal from one local oscillator unit 50. One LO signal S′_{LOnew}(t) is shifted by 90° with respect to the other signal S_{LOnew}(t). The local oscillator unit 50 is designed to provide the two LO signals with a frequency f_{LOnew}=f′_{Lonew}≦A f_{RF}, with A≧5. That is, the frequency of the two LO signals is at least 5 times lower than the frequency of the input signal s(t).

According to another embodiment of the invention, the gain loss caused by the fact that a LO signal S_{LOnew}(t) with low frequency is employed for the mixing process, is compensated by means of an amplifier. This amplifier may be positioned after the low-pass filter (LPF). That is, the amplifier amplifies the baseband signal after down-conversion and after filtering.

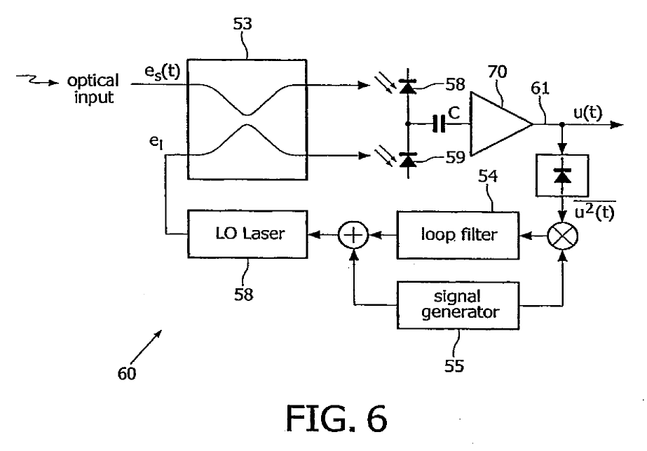

The present invention may also be used to reduce the power consumption of an optical receiver front-end 60 illustrated in FIG. 6 or in other optical receivers. The receiver front-end 60 is part of a homodyne receiver. An optical light wave eₛ(t) received by the receiver front-end 60 is superposed in a 180°-hybrid with the light wave eₗ of a local oscillator laser 58. The front end 60 comprises two photo-diodes 58 and 59 which are coupled via a capacitor C to an amplifier 70. The receiver-front end 60 provides for a down-conversion of the signal eₛ(t). At the output 61 a baseband signal u(t) is provided. The receiver front-end 60 further comprises a loop filter 54 and a signal generator 55 in a phase locked loop arrangement. The loop filter 54 and the signal generator 55 control the frequency of the local oscillator laser 58. In a conventional optical receiver, the frequency of the local oscillator laser 58 is identical to the carrier frequency of the optical light wave eₛ(t). According to the present invention, the local oscillator's frequency is reduced by at least a factor of 3. This allows to safe a substantial amount of energy, like in the RF receivers proposed herein, since the laser as well as the electronic components of the feedback loop would consume less power.

Although simple mixers are shown and described, the proposed power saving method is applicable to quadrature mixers as well. Given quadrature signals in square-wave, it can be shown that their harmonics of any order are also in quadrature.

In yet another embodiment, the mixer design is altered since the mixer now just needs to perform a multiplication at lower frequencies.

Yet another embodiment is characterized in that the whole receiver front-end, except for the antenna, is realized on one chip. The present invention is well suited for realizing a fully integrated receiver comprising a low noise amplifier, a resistive FET mixer, and a voltage controlled oscillator.

The invention can be used in homodyne receivers, super heterodyne receivers, double super heterodyne receivers, and so forth.

In this specification, receivers were described where the emphasis in development has been to minimize the DC power consumption without sacrificing any key performance parameters.

There are many direct benefits when using a lower LO frequency in accordance with the present invention:

Less self-mixing: One of the major drawbacks in a homodyne or direct-conversion receiver is the so-called self-mixing. Due to capacitive or substrate coupling, a finite amount of feed-through exists from the VCO/LO port to the input of the LNA or the input of the mixer. As a consequence, the leakage signal appearing at the inputs of the LNA and the mixer is mixed with the LO signal, thus producing a DC component at the mixer's output. As in a receiver, the gain from the antenna to an analog-to-digital converter (ADC) situated after the mixer is typically around 80 to 100 dB. A very small DC offset at the mixer's output may saturate some of the circuit in the receive chain. This leakage is frequency dependent. With a lower LO frequency, as proposed herein, the self-mixing effect is greatly reduced.

Lower noise: It has been found that the noise due to the tail capacitance of a standard mixer is proportional to ω_{LO}. So with ω_{LOnew}, a better noise performance is obtained without an increase of power consumption and without any change of the mixer circuit.

Lower intermodulation distortion: The intermodulation distortion is reduced when the LO frequency is decreased.

Less power dissipation by the VCO buffer/amplifier and the prescaler: A lower LO frequency f_{LO} means that a smaller division ratio is required by the frequency divider.

In the above, a mixer example is shown where the LO frequency is lowered by 3 and another mixer example is shown where the LO frequency is lowered by 5. As pointed out, the lowering factor A can also be any other odd integer numbers greater than 3. The choice obviously depends on the specific application, and one has to make a trade-off between attainable power reduction and the conversion gain, also the ratio in order to achieve the best overall performances.

The key specifications for a local oscillator (note that a receiver may have more than one local oscillator, depending upon the number of IFs and the system architecture) include tuning range, frequency stability, spurious output levels, lock-time, and phase noise. Most of these specifications determine an LO's suitability for a particular wireless receiver application The spurious and phase-noise performance also impact sensitivity and dynamic-range performance. Nobody so far has considered to reduce the power consumption of the receiver front-end by reducing the frequency f_{LO} of the LO, as proposed herein.

It is appreciated that various features of the invention which are, for clarity, described in the context of separate embodiments may also be provided in combination in a single embodiment. Conversely, various features of the invention which are, for brevity, described in the context of a single embodiment may also be provided separately or in any suitable sub combination.

In the drawings and specification there has been set forth preferred embodiments of the invention and, although specific terms are used, the description thus given uses terminology in a generic and descriptive sense only and not for purposes of limitation.

1. A receiver for receiving an RF signal comprising a high frequency component f_{RF}, comprising:
a local oscillator that provides a square wave local oscillator signal, the square wave local oscillator signal having a fundamental frequency component with a frequency of f_{LOnew}, where f_{LOnew} is at least one-third (⅓) of the high frequency f_{RF}, and the square wave local oscillator signal having at least one odd harmonic frequency component that is an odd multiple of the fundamental frequency component of f_{LOnew};
a first mixer that down-converts the RF signal to a desired output frequency, the first mixer has a first input to which the RF signal is applied, a second input to which the square wave local oscillator signal is applied, and an output from which a composite output signal is provided, the composite output signal including a desired output signal produced by multiplying the fundamental frequency component of the square wave local oscillator signal with the RF signal, and an undesired output signal produced by multiplying the at least one odd harmonic frequency component of the square wave local oscillator signal with the RF signal, wherein the desired output signal has an amplitude and a frequency, and wherein the undesired output signal has an amplitude greater than the amplitude of the desired output signal and has a frequency greater than the frequency of the desired output signal; and
a first filter that filters the composite output signal of the first mixer to select the desired output signal and reject the undesired output signal.

2. The receiver of claim 1, further comprising:
a phase shifter connected to the local oscillator and the first mixer, the phase shifter receives the at least one square wave local oscillator signal as an input and provides the square wave local oscillator signal, phase shifted by 90°, as an output to the first mixer;
a second mixer connected to the local oscillator, the second mixer down-converts the RF signal to the desired output frequency, the second mixer has a first input to which the RF signal is applied, a second input to which the square wave local oscillator signal is applied, and an output from which a composite output signal is provided, the composite output signal including a desired output signal produced by multiplying the fundamental frequency component of the square wave local oscillator signal with the RF signal, and an undesired output signal produced by multiplying the at least one odd harmonic frequency component of the square wave local oscillator signal with the RF signal, wherein the desired output signal has an amplitude and a frequency, and wherein the undesired output signal has an amplitude greater than the amplitude of the desired output signal and has a frequency greater than the frequency of the desired output signal; and
a second connected to the second mixer, the second filter filters the composite output signal of the second mixer to select the desired output signal and reject the undesired output signal; and
wherein the first mixer is connected to the first filter and provides the first filter with the composite output of the first mixer, wherein the first mixer multiplies the at least one square wave local oscillator signal, phase shifted by 90°, with the RF signal.

3. The receiver of claim 2, further comprising:
a first limiter connected to the first filter that receives the desired output signal of the composite output signal of the first mixer from the first filter;
a second limiter connected to the second filter that receives the desired output signal of the composite output signal of the second mixer from the second filter; and
a detector connected to the first limiter and the second limiter and that receives a respective output from the first limiter and the second limiter and extracts information from the respective outputs of the first limiter and the second limiter.

4. The receiver of claim 3 wherein the RF signal mixed by the first mixer and the second mixer is an amplified RF signal, further comprising:
an RF amplifier connected to the first mixer and the second mixer, the RF amplifier receives an input RF signal and outputs the amplified RF signal to the first mixer and the second mixer.

5. The receiver of claim 4 wherein receiver is a part of a homodyne receiver where a center frequency of a lower frequency band is defined by f_{LOnew}.

6. The receiver of claim 4 wherein receiver is a part of a hetrodyne receiver where a center frequency of a lower frequency band is defined by a frequency f_{IR} which is approximately f_{LOnew}.

7. The receiver of claim 4 wherein the fundamental frequency component is at least one-fifth (⅕) of the high frequency f_{RF}.

8. The receiver of claim 1 wherein receiver is a part of a homodyne receiver where a center frequency of a lower frequency band is defined by f_{LOnew}.

9. The receiver of claim 1 wherein receiver is a part of a hetrodyne receiver where a center frequency of a lower frequency band is defined by a frequency f_{IR} which is approximately f_{LOnew}.

10. A receiver for receiving an RF signal comprising a high frequency component f_{RF}, comprising:
an RF amplifier;
upper and lower parallel signal processing branches which receive an amplified RF signal output from the RF amplifier, wherein:
the upper signal processing branch comprises a first mixer having an output connected to a first filter, and the first filter has an output connected to a first limiter, and
the lower signal processing branch comprises a second mixer having an output connected to a second filter, and the second filter has an output connected to a second limiter;
a local oscillator for providing a respective local oscillator signal to each of the upper and lower parallel signal processing branches;
said first mixer for performing a multiplication with a first local oscillator signal S′_{LOnew}(t) from the local oscillator (LO) that is phase shifted by 90° and having a frequency f′_{LOnew};
said second mixer for performing a multiplication with a second local oscillator signal S_{LOnew}(t) from said local oscillator (LO) that is not phase shifted and having a frequency f_{LOnew};
a detector receiving a respective output from both the first limiter and the second limiter and for extracting information from the received outputs;
wherein the frequency of the first signal f′_{LOnew} and second f_{LOnew} output by said local oscillator LO conforms with the following:
A f_{LOnew}=A f′_{LOnew}≦f_{RF}, with A≧5.

11. The receiver of claim 10 wherein receiver is a part of a homodyne receiver where a center frequency of a lower frequency band is defined by f_{LOnew}.

12. The receiver of claim 10 wherein receiver is a part of a hetrodyne receiver where a center frequency of a lower frequency band is defined by a frequency f_{IR} which is approximately f_{LOnew}.

13. The receiver of claim 1 wherein the local oscillator provides a respective square wave local oscillator signal to each of the upper and lower parallel signal processing branches.

14. A method of receiving an RF signal having a high frequency component f_{RF}, comprising receiver for receiving an RF signal comprising a high frequency component f_{RF}, comprising:
providing a local square wave oscillator signal having a fundamental frequency component with a frequency f_{LOnew} that is at least one-third (⅓) of the high frequency component f_{RF} and having at least one odd harmonic component that is a odd multiple of the fundamental frequency component;
down-converting the RF signal to a desired output frequency by multiplicatively mixing the RF signal with the fundamental frequency component of the local square wave oscillator signal and by multiplicatively mixing the RF signal with the having at least one odd harmonic component of the local square wave oscillator signal; and
applying a filter to select a desired signal, where the desired signal is the product of the RF signal multiplicatively mixed with the fundamental frequency component.

15. The method of claim 14 wherein the fundamental frequency component is at least one-fifth (⅕) of the high frequency f_{RF}.

16. The method of claim 14 wherein providing a local square wave oscillator signal having a fundamental frequency component with a frequency f_{LOnew} that is at least one-third (⅓) of the high frequency component f_{RF} and having at least one odd harmonic component that is a odd multiple of the fundamental frequency component comprises:
receiving the local square wave oscillator signal at a phase shifter;
shifting the phase of the received local square wave oscillator signal by 90° at the phase shifter;
providing the phase shifted local square wave oscillator signal to a first mixer; and
providing the local square wave oscillator signal to a second mixer.

17. The method of claim 16 down-converting the RF signal to a desired output frequency by multiplicatively mixing the RF signal with the fundamental frequency component of the local square wave oscillator signal and by multiplicatively mixing the RF signal with the having at least one odd harmonic component of the local square wave oscillator signal comprises:
multiplicatively mixing the RF signal with the fundamental frequency component of the phase shifted local square wave oscillator signal at the first mixer;
multiplicatively mixing the RF signal with the at least one odd harmonic component of the phase shifted local square wave oscillator signal at the first mixer;
multiplicatively mixing the RF signal with the fundamental frequency component of the local square wave oscillator signal at the second mixer; and
multiplicatively mixing the RF signal with the at least one odd harmonic component of the local square wave oscillator signal at the second mixer.
